(19) United States
(12) Patent Application Publication
(10) Pub. No.: US 2015/0361238 A1
(43) Pub. Date: Dec. 17, 2015

(54) THERMOPLASTIC RESIN FOAM INCLUDING FLUORINE-CONTAINING HIGHLY BRANCHED POLYMER

(71) Applicants: YAMAGATA UNIVERSITY, Yamagata (JP); NISSAN CHEMICAL INDUSTRIES, LTD., Tokyo (JP)

(72) Inventors: Masataka SUGIMOTO, Yonezawa-shi (JP); Motonobu MATSUYAMA, Funabashi-shi (JP)

(21) Appl. No.: 14/646,185

(22) PCT Filed: Nov. 21, 2013
(86) PCT No.: PCT/JP2013/081421

§ 371 Date: Aug. 13, 2015

(30) Foreign Application Priority Data
Nov. 21, 2012 (JP) 2012-255364

(51) Int. Cl. C08J 9/00

(52) U.S. Cl. CPC C08J 9/0061; C08J 2333/12; C08J 2333/16

(57) ABSTRACT

A thermoplastic resin foam that is formed of a thermoplastic resin composition including 100 parts by mass of a thermoplastic resin and 0.001 to 30 parts by mass of a fluorine-containing highly branched polymer, wherein the fluorine-containing highly branched polymer is a fluorine-containing highly branched polymer that is obtained by polymerizing a monomer A having in a molecule two or more radical-polymerizable double bonds with a monomer B having in a molecule a fluoroalkyl group and at least one radical-polymerizable double bond, in presence of a polymerization initiator C in an amount of 5 to 200 mol % with respect to the number of moles of the monomer A; and a method for producing the foam.

### TECHNICAL FIELD

The present invention relates to a thermoplastic resin foam including a fluorine-containing highly branched polymer and a method for producing the thermoplastic resin foam.

### BACKGROUND ART

Polymer (macromolecular) materials have been increasingly utilized in many fields in recent years. Accordingly, features based on properties and shapes of polymers as matrices are important for the respective fields.

A thermoplastic resin foam formed by foam processing is much lighter than a non-foamed products because of the presence of many air cells in resin, and further can have various features such as flexibility, heat resistance, shock-absorbing properties, pliability, heat-insulating properties, electrical-insulating properties. Thus, such a thermoplastic resin foam is widely used for automobile parts, houses, plastic containers, and coatings for electric wires or cables, for example.

It is known that the features of the foam appear mainly depending on the cell diameter or the cell number density, and achieving a finer cell diameter in a foam is one of great technical challenges.

As a conventional technique for achieving a finer cell diameter, a method is known in which a resin composition of a polyolefin resin containing an organic peroxide and a pyrolytic foaming agent into which fluorine-containing compound fine particles and silicone fine particles are added is heated to foam the polyolefin resin (Patent Document 1).

As a method for achieving a finer cell diameter and a higher cell number density, a method is widely known in which a supercritical fluid is impregnated into a resin and the resin is rapidly decompressed from high pressure. As a method for producing a foam in which supercritical fluid is used as a foaming agent, a method is described in which a resin composition of a polycarbonate resin with a fluorine-based surfactant added is used (Patent Document 2).

### PRIOR ART DOCUMENTS

### Patent Documents

Patent Document 1: Japanese Patent Application Publication No. 2004-10721 (JP 2004-10721 A)
Patent Document 2: Japanese Patent Application Publication No. 2008-127467 (JP 2008-127467 A)

### SUMMARY OF THE INVENTION

### Problem to be Solved by the Invention

However, the methods for achieving a finer cell diameter disclosed in these Patent Documents can be used only under specific foaming conditions. In particular, the technique using supercritical fluid described in Patent Document 2 requires impregnation of the supercritical fluid under extremely high pressure, accordingly requiring a facility that can endure such a high pressure, and there still remain issues in operational safety. Furthermore, because dispersibility of a foaming agent in a resin is poor, a uniform finer size cannot be sufficiently achieved at present.

In view of this, a resin composition has been desired that makes it possible to uniformly densify, in a resin, cell nuclei generated when a supercritical fluid is impregnated into the resin and the resin is rapidly decompressed from high pressure. Furthermore, the resin composition has been desired that makes it possible to achieve a finer size and a higher density of cells in the subsequent growth of the cells, and can also be foamed under moderate conditions. In addition, a foam has been desired in which a finer size and a higher density of the cells can be achieved.

### Means for Solving the Problem

As a result of intensive studies to achieve the objects described above, the inventors of the present invention found that addition of a fluorine-containing highly branched polymer enables both a finer size of cells and a higher density of cell number.

Specifically, the present invention relates to, as a first aspect, a thermoplastic resin foam that is formed of a thermoplastic resin composition comprising 100 parts by mass of a thermoplastic resin (a) and 0.001 to 30 parts by mass of a fluorine-containing highly branched polymer (b), in which the fluorine-containing highly branched polymer (b) is a fluorine-containing highly branched polymer that is obtained by polymerizing a monomer A having, in a molecule, two or more radical-polymerizable double bonds with a monomer B having, in a molecule, a fluoroalkyl group and at least one radical-polymerizable double bond, in presence of a polymerization initiator C in an amount of 5 to 200 mol % with respect to the number of moles of the monomer A.

The present invention relates to, as a second aspect, the thermoplastic resin foam according to the first aspect, in which the monomer B is a compound that has at least either one of a vinyl group and a (meth)acrylic group.

The present invention relates to, as a third aspect, the thermoplastic resin foam according to the second aspect, in which the monomer B is a compound of Formula [1]:

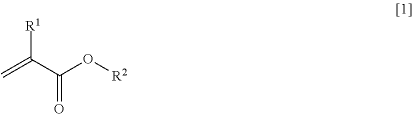

(in the formula, R¹ is a hydrogen atom or a methyl group, and R² is a C₂₋₁₂ fluoroalkyl group that is optionally substituted with a hydroxy group).

The present invention relates to, as a fourth aspect, the thermoplastic resin foam according to the second aspect, in which the monomer B is a compound of Formula [2]:

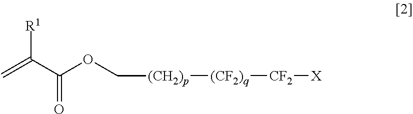

(in the formula, R¹ is a hydrogen atom or a methyl group, X is a hydrogen atom or a fluorine atom, p is an integer of 1 or 2, and q is an integer of 0 to 5).

The present invention relates to, as a fifth aspect, the thermoplastic resin foam according to any one of the first aspect to the fourth aspect, in which the monomer A is a compound having either one or both of a vinyl group and a (meth)acrylic group.

The present invention relates to, as a sixth aspect, the thermoplastic resin foam according to the fifth aspect, in which the monomer A is a divinyl compound or a di(meth)acrylate compound.

The present invention relates to, as a seventh aspect, the thermoplastic resin foam according to the fifth aspect, in which the monomer A is divinylbenzene or ethylene glycol di(meth)acrylate.

The present invention relates to, as an eighth aspect, the thermoplastic resin foam according to any one of the first aspect to the seventh aspect, in which the fluorine-containing highly branched polymer (b) is a fluorine-containing highly branched polymer that is obtained by polymerizing the monomer B in an amount of 5 to 300 mol % with respect to the number of moles of the monomer A.

The present invention relates to, as a ninth aspect, the thermoplastic resin foam according to any one of the first aspect to the eighth aspect, in which the thermoplastic resin (a) is at least one thermoplastic resin selected from the group consisting of a poly(meth)acrylate resin and a styrene resin.

The present invention relates to, as a tenth aspect, the thermoplastic resin foam according to any one of the first aspect to the eighth aspect, in which the thermoplastic resin (a) is at least one thermoplastic resin selected from the group consisting of poly(methyl methacrylate), polystyrene, and an acrylonitrile-styrene copolymer.

The present invention relates to, as an eleventh aspect, a method for producing a thermoplastic resin foam, the method comprising the steps of; impregnating a supercritical fluid into a thermoplastic resin composition containing 100 parts by mass of a thermoplastic resin (a) and 0.001 to 30 parts by mass of a fluorine-containing highly branched polymer (b) under high pressure; and rapidly decompressing the thermoplastic resin composition into which the supercritical fluid is impregnated from high pressure, in which the fluorine-containing highly branched polymer (b) is a fluorine-containing highly branched polymer that is obtained by polymerizing a monomer A having, in a molecule, two or more radical-polymerizable double bonds with a monomer B having, in a molecule, a fluoroalkyl group and at least one radical-polymerizable double bond, in presence of a polymerization initiator C in an amount of 5 to 200 mol % with respect to the number of moles of the monomer A.

The present invention relates to, as a twelfth aspect, the production method according to the eleventh aspect, in which the thermoplastic resin (a) is at least one thermoplastic resin selected from the group consisting of a poly(meth)acrylate resin and a styrene resin.

The present invention relates to, as a thirteenth aspect, the production method according to the eleventh aspect, in which the thermoplastic resin (a) is at least one thermoplastic resin selected from the group consisting of poly(methyl methacrylate), polystyrene, and an acrylonitrile-styrene copolymer.

### Effects of the Invention

The thermoplastic resin foam of the present invention is a foam in which fine cells are present in a densely and uniformly distributed manner, and thus improvement of heat insulating properties and mechanical strength can be expected.

By the method for producing the thermoplastic resin foam of the present invention, uniform fine cells can be generated throughout the resin, whereby a foam that uniformly and densely contains fine cells can be obtained.

### BRIEF DESCRIPTION OF THE DRAWINGS

FIG. 1 is a diagram illustrating a ¹³C NMR spectrum of a fluorine-containing highly branched polymer FHBP1 obtained in Synthesis Example 1.

FIG. 2 is a diagram illustrating a ¹³C NMR spectrum of a fluorine-containing highly branched polymer FHBP2 obtained in Synthesis Example 2.

FIG. 3 is a diagram illustrating a ¹³C NMR spectrum of a non-fluorine-based highly branched polymer HBP1 obtained in Synthesis Example 3.

FIG. 4 is a diagram illustrating a cross-sectional SEM image of a PMMA foam obtained in Example 3.

### MODES FOR CARRYING OUT THE INVENTION

### Thermoplastic Resin Foam

A thermoplastic resin foam of the present invention is formed of a thermoplastic resin composition including a thermoplastic resin (a) and a fluorine-containing highly branched polymer (b).

[Thermoplastic Resin (a)]

The thermoplastic resin (a) is not limited to particular one, and examples thereof include polyolefin resins such as polyethylene (PE), polypropylene (PP), an ethylene-propylene copolymer, an ethylene-vinyl alcohol copolymer (EVOH), an ethylene-vinyl acetate copolymer (EVA), and an ethylene-ethyl acrylate copolymer (EEA); styrene resins such as polystyrene (PS), high-impact polystyrene (HIPS), an acrylonitrile-styrene copolymer (AS), a styrene-butadiene copolymer, an acrylonitrile-butadiene-styrene copolymer (ABS), and a methyl methacrylate-styrene copolymer (MS); polycarbonate resins; vinyl chloride resins; poly(vinylidene chloride) resins; polyamide resins such as nylon 6 and nylon 6,6; polyimide resin; poly(meth)acryl resins such as poly(methyl methacrylate) (PMMA); polyester resins such as poly(ethylene terephthalate) (PET), poly(butylene terephthalate) (PBT), poly(ethylene naphthalate) (PEN), poly(butylene naphthalate) (PBN), poly(butylene succinate), poly(ethylene succinate/adipate), poly(lactic acid) (PLA), poly(3-hydroxybutyric acid), and poly(caprolactone); poly(phenylene ether) resins; modified poly(phenylene ether) resins; polyacetal resins; polysulfone resins; sulfide resins such as a poly(phenylene sulfide) resin; poly(vinyl alcohol) resins; polyglycol resins; modified starch; cellulose acetate and cellulose triacetate; chitin and chitosan; and lignin. Among these, styrene resins and poly(meth)acryl resins are preferred, PS, AS, and PMMA are more preferred, and PMMA is particularly preferred.

[Fluorine-Containing Highly Branched Polymer (b)]

The fluorine-containing highly branched polymer (b) is a polymer that is obtained by polymerizing a monomer A having, in a molecule, two or more radical-polymerizable double bonds with a monomer B having, in a molecule, a fluoroalkyl group and at least one radical-polymerizable double bond, in the presence of a polymerization initiator C in an amount of 5 to 200 mol % with respect to the number of moles of the monomer A.

The fluorine-containing highly branched polymer (b) may be obtained by polymerizing another monomer that does not belong to the monomer A or the monomer B as long as the effects of the present invention are not impaired.

The fluorine-containing highly branched polymer (b) is a fluorine-containing highly branched polymer in a type of what is called an initiator-fragment incorporation radical polymerization (IFIRP), and has at its end a fragment of the polymerization initiator C that has been used for polymerization.

[Monomer A]

In the present invention, the monomer A having, in a molecule, two or more radical-polymerizable double bonds preferably has either one or both of a vinyl group and a (meth)acrylic group, and is particularly preferred to be a divinyl compound or a di(meth)acrylate compound. In the present invention, the (meth)acrylate compound means both of an acrylate compound and a methacrylate compound. For example, a (meth)acrylic acid means an acrylic acid and a methacrylic acid.

As the monomer A, organic compounds of (A1) to (A7) are exemplified.

(A1) vinyl hydrocarbons:
(A1-1) aliphatic vinyl hydrocarbons; isoprene, butadiene, 3-methyl-1,2-butadiene, 2,3-dimethyl-1,3-butadiene, 1,2-polybutadiene, pentadiene, hexadiene, octadiene, etc.
(A1-2) alicyclic vinyl hydrocarbons; cyclopentadiene, cyclohexadiene, cyclooctadiene, norbornadiene, etc.
(A1-3) aromatic vinyl hydrocarbons; divinylbenzene, divinyltoluene, divinylxylene, trivinylbenzene, divinylbiphenyl, divinylnaphthalene, divinylfluorene, divinylcarbazole, divinylpyridine, etc.
(A2) vinyl esters, allyl esters, vinyl ethers, allyl ethers, and vinyl ketones:
(A2-1) vinyl esters; divinyl adipate, divinyl maleate, divinyl phthalate, divinyl isophthalate, divinyl itaconate, vinyl(meth)acrylate, etc.
(A2-2) allyl esters; diallyl maleate, diallyl phthalate, diallyl isophthalate, diallyl adipate, allyl(meth)acrylate, etc.
(A2-3) vinyl ethers; divinyl ether, diethylene glycol divinyl ether, triethylene glycol divinyl ether, etc.
(A2-4) allyl ethers; diallyl ether, diallyloxyethane, triallyloxyethane, tetraallyloxyethane, tetraallyloxypropane, tetraallyloxybutane, tetramethallyloxyethanes, etc.
(A2-5) vinyl ketones; divinyl ketone, diallyl ketone, etc.
(A3) (meth)acrylic acid esters:
ethylene glycol di(meth)acrylate, triethylene glycol di(meth)acrylate, propylene glycol di(meth)acrylate, neopentyl glycol di(meth)acrylate, trimethylolpropane tri(meth)acrylate, ditrimethylolpropane tetra(meth)acrylate, glycerol tri(meth)acrylate, pentaerythritol tetra(meth)acrylate, alkoxytitanium tri(meth)acrylate, 1,6-hexanediol di(meth)acrylate, 2-methyl-1,8-octanediol di(meth)acrylate, 1,9-nonanediol di(meth)acrylate, 1,10-decanediol di(meth)acrylate, tricyclo[5.2.1.0^{2,6}]decanedimethanol di(meth)acrylate, dioxane glycol di(meth)acrylate, 2-hydroxy-1-acryloyloxy-3-methacryloyloxypropane, 2-hydroxy-1,3-di(meth)acryloyloxypropane, 9,9-bis[4-(2-(meth)acryloyloxyethoxy)phenyl]fluorene, undecylenoxyethylene glycol di(meth)acrylate, bis[4-(meth)acryloylthiophenyl]sulfide, bis[2-(meth)acryloylthioethyl]sulfide, 1,3-adamantanediol di(meth)acrylate, 1,3-adamantanedimethanol di(meth)acrylate, methoxylated bisphenol A di(meth)acrylate, ethoxylated bisphenol A di(meth)acrylate, (the number of moles of the added ethyleneoxy group: 2.3 mol, 2.6 mol, 3 mol, 4 mol, 10 mol, 17 mol, etc.), propoxylated bisphenol A di(meth)acrylate, propoxylated ethoxylated bisphenol A di(meth)acrylate (adduct of 12 mol of propyleneoxy group/6 mol of ethyleneoxy group, etc.), aromatic urethane di(meth)acrylate, aliphatic urethane di(meth)acrylate, etc.
(A4) poly(alkylene glycol) chain-containing vinyl compounds:
poly(ethylene glycol) (molecular weight: 300) di(meth)acrylate and polypropylene glycol) (molecular weight: 500) di(meth)acrylate, etc.
(A5) nitrogen-containing vinyl compounds:
diallylamine, diallyl isocyanurate, diallyl cyanurate, methylenebis(meth)acrylamide, bismaleimide, etc.
(A6) silicon-containing vinyl compounds:
dimethyldivinylsilane, methyl(phenyl)divinylsilane, diphenyldivinylsilane, 1,1,3,3-tetramethyl-1,3-divinyldisilazane, 1,1,3,3-tetraphenyl-1,3-divinyldisilazane, diethoxydivinylsilane, etc.
(A7) fluorine-containing vinyl compounds:
1,4-divinylperfluorobutane, 1,6-divinylperfluorohexane, 1,8-divinylperfluorooctane, etc.

Preferred among these are aromatic vinyl hydrocarbons in (A1-3); vinyl esters, allyl esters, vinyl ethers, allyl ethers, and vinyl ketones in (A2); (meth)acrylic acid esters in (A3); poly(alkylene glycol) chain-containing vinyl compounds in (A4); and nitrogen-containing vinyl compounds in (A5). Particularly preferred are divinylbenzene in (A1-3); diallyl phthalate in (A2); ethylene glycol di(meth)acrylate, 1,3-adamantanedimethanol di(meth)acrylate, tricyclo[5.2.1.0²′⁶]decanedimethanol di(meth)acrylate, 2-hydroxy-1-acryloyloxy-3-methacryloyloxypropane, and aliphatic urethane di(meth)acrylate in (A3); and methylenebis(meth)acrylamide in (A5). Among these, divinylbenzene and ethylene glycol di(meth)acrylate are particularly preferred.

[Monomer B]

In the present invention, the monomer B having, in a molecule, a fluoroalkyl group and at least one radical-polymerizable double bond preferably has at least either one of a vinyl group and a (meth)acrylic group, is particularly preferred to be the compound of Formula [1] above, and is further preferred to be the compound of Formula [2] above.

Examples of the monomer B include 2,2,2-trifluoroethyl(meth)acrylate, 2,2,3,3,3-pentafluoropropyl(meth)acrylate, 2-(perfluorobutyl)ethyl(meth)acrylate, 2-(perfluorohexyl)ethyl(meth)acrylate, 2-(perfluorooctyl)ethyl(meth)acrylate, 2-(perfluorodecyl)ethyl(meth)acrylate, 2-(perfluoro-3-methylbutyl)ethyl(meth)acrylate, 2-(perfluoro-5-methylhexyl)ethyl(meth)acrylate, 2-(perfluoro-7-methyloctyl)ethyl(meth)acrylate, 2,2,3,3-tetrafluoropropyl(meth)acrylate, 1H,1H,5H-octafluoropentyl(meth)acrylate, 1H,1H,7H-dodecafluoroheptyl(meth)acrylate, 1H,1H,9H-hexadecafluorononyl(meth)acrylate, 1H-1-(trifluoromethyl)trifluoroethyl(meth)acrylate, 1H,1H,3H-hexafluorobutyl(meth)acrylate, 3-perfluorobutyl-2-hydroxypropyl(meth)acrylate, 3-perfluorohexyl-2-hydroxypropyl(meth)acrylate, 3-perfluorooctyl-2-hydroxypropyl(meth)acrylate, 3-(perfluoro-3-methylbutyl)-2-hydroxypropyl(meth)acrylate, 3-(perfluoro-5-methylhexyl)-2-hydroxypropyl(meth)acrylate, and 3-(perfluoro-7-methyloctyl)-2-hydroxypropyl(meth)acrylate.

In the present invention, from the viewpoint of reactivity, dispersibility in the component (a), and foamability, the use amount of the monomer B is preferably 5 to 300 mol %, particularly preferably 10 to 150 mol %, and more preferably 20 to 100 mol % with respect to the number of moles of the monomer A used.

[Another Monomer]

In the present invention, the other monomer that does not belong to the monomer A or the monomer B is not limited to particular one as long as it is a monomer having one radical-polymerizable double bond in a molecule, but is preferred to be a vinyl compound or a (meth)acrylate compound.

In the present invention, the use amount of the other monomer is preferably 5 to 300 mol % with respect to the number of moles of the monomer A used.

[Polymerization Initiator C]

As the polymerization initiator C in the present invention, an azo polymerization initiator is preferably used. Examples of the azo polymerization initiator include compounds of (1) to (5) below.

(1) azonitrile compounds:
2,2′-azobisisobutyronitrile, 2,2′-azobis(2-methylbutyronitrile),
2,2′-azobis(2,4-dimethylvaleronitrile), 1,1′-azobis(1-cyclohexanecarbonitrile),
2,2′-azobis(4-methoxy-2,4-dimethylvaleronitrile), 2-(carbamoylazo)isobutyronitrile, etc.
   (2) azoamide compounds:
2,2′-azobis {2-methyl-N-[1,1-bis(hydroxymethyl)-2-hydroxyethyl]propionamide},
2,2′-azobis {2-methyl-N-[2-(1-hydroxybutyl)]propionamide},
2,2′-azobis[2-methyl-N-(2-hydroxyethyl)propionamide],
2,2′-azobis[N-(2-propenyl)-2-methylpropionamide],
2,2′-azobis(N-butyl-2-methylpropionamide),
2,2′-azobis(N-cyclohexyl-2-methylpropionamide), etc.
   (3) cyclic azoamidine compounds:
2,2′-azobis[2-(2-imidazolin-2-yl)propane]dihydrochloride,
2,2′-azobis[2-(2-imidazolin-2-yl)propane]disulfate dihydrate,
2,2′-azobis[2-[1-(2-hydroxyethyl)-2-imidazolin-2-yl]propane]dihydrochloride,
2,2′-azobis[2-(2-imidazolin-2-yl)propane],
2,2′-azobis(1-imino-1-pyrrolidino-2-methylpropane)dihydrochloride, etc.
   (4) azoamidine compounds:
2,2′-azobis(2-methylpropionamidine)dihydrochloride,
2,2′-azobis[N-(2-carboxyethyl)-2-methylpropionamidine]tetrahydrate, etc.
   (5) others:
dimethyl 2,2′-azobisisobutyrate, 4,4′-azobis(4-cyanovaleric acid),
2,2′-azobis(2,4,4-trimethylpentane), 1,1′-azobis(1-acetoxy-1-phenylethane), dimethyl
1,1′-azobis(1-cyclohexanecarboxylate), bis(2-(perfluoromethyl)ethyl)
4,4′-azobis(4-cyanovalerate), bis(2-(perfluorobutyl)ethyl) 4,4′-azobis(4-cyanovalerate),
bis(2-(perfluorohexyl)ethyl) 4,4′-azobis(4-cyanovalerate), etc.

Among these azo polymerization initiators, from the viewpoint of dispersibility of obtained highly branched polymers into the component (a), 2,2′-azobis(2-methylbutyronitrile) and dimethyl 2,2′-azobisisobutyrate are preferred, and dimethyl 2,2′-azobisisobutyrate is particularly preferred.

The polymerization initiator C is used in an amount of 5 to 200 mol % with respect to the number of moles of the monomer A, and is preferably used in an amount of 20 to 200 mol %, and more preferably 20 to 150 mol %.

[Method for Producing Fluorine-Containing Highly Branched Polymer]

The fluorine-containing highly branched polymer (b) is obtained by polymerizing the monomer A with the monomer B in the presence of a predetermined amount of the polymerization initiator C with respect to the monomer A. Examples of the polymerization method include known methods such as solution polymerization, dispersion polymerization, precipitation polymerization, and bulk polymerization, and among these, solution polymerization and precipitation polymerization are preferred. In particular, in view of molecular weight control, the reaction is preferably performed by solution polymerization in an organic solvent.

Examples of the organic solvent used herein include aromatic hydrocarbons such as benzene, toluene, xylene, ethylbenzene, and tetralin; aliphatic or alicyclic hydrocarbons such as n-hexane, n-heptane, mineral spirits, and cyclohexane; halides such as methyl chloride, methyl bromide, methyl iodide, methylene dichloride, chloroform, carbon tetrachloride, trichloroethylene, perchloroethylene, and o-dichlorobenzene; esters or ester ethers such as ethyl acetate, butyl acetate, methoxybutyl acetate, methyl cellosolve acetate, ethyl cellosolve acetate, and propylene glycol monomethyl ether acetate (PGMEA); ethers such as diethyl ether, tetrahydrofuran (THF), 1,4-dioxane, methyl cellosolve, ethyl cellosolve, butyl cellosolve, and propylene glycol monomethyl ether (PGME); ketones such as acetone, methyl ethyl ketone (MEK), methyl isobutyl ketone (MIBK), di-n-butyl ketone, and cyclohexanone; alcohols such as methanol, ethanol, n-propanol, isopropanol, n-butanol, isobutanol, tert-butanol, 2-ethylhexyl alcohol, benzyl alcohol, and ethylene glycol; amides such as N,N-dimethylformamide (DMF), N,N-dimethylacetamide, and N-methyl-2-pyrrolidone (NMP); and sulfoxides such as dimethylsulfoxide (DMSO). These organic solvents may be used singly or in combination of two or more types thereof.

Among these, aromatic hydrocarbons, halides, esters, ethers, ketones, alcohols, and amides, for example, are preferred. Particularly preferred thereamong are benzene, toluene, xylene, o-dichlorobenzene, ethyl acetate, butyl acetate, propylene glycol monomethyl ether acetate (PGMEA), propylene glycol monomethyl ether (PGME), tetrahydrofuran (THF), 1,4-dioxane, methyl ethyl ketone (MEK), methyl isobutyl ketone (MIBK), methanol, ethanol, n-propanol, isopropanol, n-butanol, isobutanol, tert-butanol, N,N-dimethylformamide (DMF), N,N-dimethylacetamide, and N-methyl-2-pyrrolidone (NMP), for example.

When the polymerization reaction is performed in the presence of an organic solvent, the amount of the organic solvent with respect to 1 part by mass of the monomer A is generally 5 to 120 parts by mass, and is preferably 10 to 110 parts by mass.

The polymerization reaction is performed under normal pressure, under increased pressure in a sealed condition, or under reduced pressure, and is preferably performed under normal pressure because of the simplicity of apparatus and operation therefor. The polymerization reaction is also preferably performed in an atmosphere of an inert gas such as N₂.

The polymerization temperature can be set as desired as long as it is equal to or lower than the boiling point of reaction mixture, but is preferably 50 to 200° C., further preferably 80 to 150° C., and more preferably 80 to 130° C. in view of polymerization efficiency and molecular-weight control.

The polymerization time cannot be generally specified because it varies depending on the reaction temperature, types and ratios of the monomer A, the monomer B, and the polymerization initiator C, and types of the polymerization solvent, for example, but is preferably 30 to 720 minutes, and more preferably 40 to 540 minutes.

After the completion of the polymerization reaction, the obtained fluorine-containing highly branched polymer is collected by any given method to perform posttreatment such as washing if needed. Examples of the method for collecting polymers from the reaction solution include methods such as reprecipitation.

The weight-average molecular weight (Mw) of the fluorine-containing highly branched polymer (b) measured by gel permeation chromatography with polystyrene standards is 1,000 to 400,000, and is preferably 2,000 to 200,000.

In the thermoplastic resin composition according to the present invention, the blending amount of the fluorine-containing highly branched polymer (b) is 0.001 to 30 parts by mass, preferably 0.005 to 10 parts by mass, and more preferably 0.01 to 10 parts by mass with respect to 100 parts by mass of the thermoplastic resin (a).

[Other Additives]

In the thermoplastic resin composition according to the present invention, additives that are generally added with the thermoplastic resin may be used together. Examples of the additives include a heat stabilizer, a light stabilizer, an antioxidant, an ultraviolet absorber, a lubricant, a mold-release agent, an antistatic agent, a melt-elasticity modifier, a processing aid, a cross-linking agent, a reinforcing agent, a flame retardant, an antifoaming agent, a dispersant, a light-diffusing agent, a pigment, a dye, and a fluorescent dye.

<Method for Producing Thermoplastic Resin Foam>

As described above, the thermoplastic resin foam of the present invention is formed of a thermoplastic resin composition that includes the thermoplastic resin (a) and the fluorine-containing highly branched polymer (b) and, if desired, the other additives.

The thermoplastic resin composition used for the foam is obtained, for example, by a method of adding the thermoplastic resin (a), the fluorine-containing highly branched polymer (b), and the additives as required, and then melting and kneading these. Examples of specific means for the melting and kneading include a Banbury mixer, a roll kneader, an extruder, and a static mixer. Typical examples of the extruder include various types of single-screw extruders, twin-screw extruders, and multiple-screw extruders having three or more screws.

Alternatively, the thermoplastic resin composition may be obtained by using a method of mixing together a solvent such as toluene during mixing of the component (a) and the component (b), for example, to form a solution and then removing the solvent if needed.

Examples of the method for producing the thermoplastic resin foam include a method of foaming the thermoplastic resin composition with a supercritical fluid and a method in which a chemical foaming agent is blended into the composition to form a mixed raw material and this mixed raw material is foamed.

The foam formed with a supercritical fluid has no odor unlike the foam formed with a chemical foaming agent and is excellent in recyclability and cushioning properties, and thus is preferred in the present invention.

Specifically, the thermoplastic resin foam of the present invention can be preferably produced by, for example,

1) a step of impregnating a supercritical fluid into the thermoplastic resin composition containing 100 parts by mass of the thermoplastic resin (a) and 0.001 to 30 parts by mass of the fluorine-containing highly branched polymer (b) under high pressure, and subsequently
2) a step of rapidly decompressing the thermoplastic resin composition into which the supercritical fluid is impregnated from high pressure.

<1) Step of Impregnating Supercritical Fluid into Thermoplastic Resin Composition Under High Pressure>

As a supercritical fluid used for this step, carbon dioxide, ammonia, nitrogen, or methane, for example, that is brought into a supercritical state can be used. In particular, carbon dioxide can be brought into a supercritical state by setting the temperature at 31.1° C. or higher and the pressure at 7.3 MPa or higher, and thus can be in the supercritical state at temperatures and pressures that are relatively low. Accordingly, carbon dioxide is preferred from a viewpoint that a foam can be easily produced in a stable manner. The supercritical fluid of carbon dioxide can be injected at a high concentration because the impregnating speed thereof into the thermoplastic resin composition (molten matter) is high. Accordingly, the supercritical fluid of carbon dioxide is preferred from a viewpoint of being suitable for foam molding and being able to form finer cells.

As a method of impregnating a supercritical fluid into the thermoplastic resin composition under high pressure, either of a method of impregnating the supercritical fluid into the composition in a molten state or a method of impregnating the supercritical fluid into the composition in a solid state can be selected, and the latter method is particularly preferred.

The solid state herein is a state in which melt processing is difficult even when the temperature exceeds the softening temperature of the resin (composition). As the upper limit of temperatures thereof, a temperature that is higher than the glass-transition temperature (Tg (° C.)) of the resin (composition) by about 20° C. is exemplified.

One example of a specific method of impregnating a supercritical fluid into the resin composition in the solid state can be performed by causing the resin composition in the solid state to coexist with gas such as carbon dioxide, adjusting the temperature and the pressure to use the gas as a supercritical fluid, and maintaining this state for a certain period of time.

Because the impregnating speed of gas generally depends on the state of plasticization of resin molecules, setting the temperature rather high is advantageous for increasing the impregnating speed. To obtain finer cells in a foam, it is preferable that the temperature during decompression be close to the glass-transition temperature (Tg) of a resin that is plasticized by impregnation of gas. Tg of a resin during impregnation of gas differs depending on the type of the resin and the impregnation amount of the gas. In view of these, it is preferable that the temperature for impregnation of the supercritical fluid be equal to or lower than Tg of the resin (composition), and it is also preferable that the temperature during the impregnation be approximately constant to stably produce a foam in the subsequent steps.

The gas such as carbon dioxide used as the supercritical fluid may be in a state of being injected into a sealed container such as an autoclave and being placed with the resin composition in a sealed condition. Alternatively, the gas may be in a state of being circulated and being in contact with the resin composition.

In the impregnation of the supercritical fluid into the resin composition, it is preferable that impregnation be performed until saturated concentration is almost reached as close as possible. However, in a case that it takes time for this process, attention is required because productivity deteriorates, and if not a little part of the resin crystallizes, crystallization makes the resin hard to be foamed.

As described above, optimum conditions of temperature and pressure, for example, can be obtained so as to achieve both optimized impregnating speed of the supercritical fluid and a finer size of cells. For example, the pressure can appropriately selected from 1 to 50 MPa, the temperature can be appropriately selected, for the thermoplastic resin used, from Tg±100° C., preferably Tg±50° C., and more preferably Tg±20° C., and the retention time can be appropriately selected from 0.1 to 24 hours.

This step may be either batch-wise or continuous one.

<2) Step of Rapidly Decompressing Thermoplastic Resin Composition into which Supercritical Fluid is Impregnated from High Pressure>

Subsequently, by rapidly decompressing the system that is under high pressure, the supercritical fluid impregnated (dissolved) into the composition vaporizes, and thus a foam is formed.

As a method for shaping this foam, any of a method of shaping the resin composition before impregnation of the supercritical fluid, a method of shaping the resin composition during decompression, and a method of further heating after the decompression and then shaping the resin composition can be selected.

The thermoplastic resin foam of the present invention contains a specific fluorine-containing highly branched polymer as one component thereof. This highly branched polymer, because of its branched structure that is actively employed, involves less entanglement between molecules compared with a linear polymer, and exhibits behavior like fine particles. Accordingly, the fluorine-containing highly branched polymer is prevented from flocculating in the resin that is a matrix, and thus has a property of easily dispersing throughout the resin.

The fluoroalkyl group contained in the fluorine-containing highly branched polymer has a high affinity with a supercritical fluid, particularly with carbon dioxide. It is thus considered that a resin composition containing this polymer enables the impregnating amount of carbon oxide to be increased, and also enables the impregnation of carbon dioxide to be spread throughout the resin by the fluorine-containing highly branched polymer highly dispersed throughout the resin. Accordingly, it is considered that uniform and fine cells can be formed throughout the resin, whereby a foam that contains the fine cells in a uniform and dense manner can be obtained.

In the thermoplastic resin foam of the present invention, the average cell diameter of cells formed inside the foam in particular is preferably 1 μm or smaller, and further preferably 0.8 μm or smaller. The cell number density (the number of cells per unit volume) is preferably 100×10¹⁰ cell/cm³ or more, and further preferably 200×10¹⁰ cell/cm³ or more. By setting the average cell diameter to 1 μm or smaller and the cell number density to 100×10¹⁰ cell/cm³ or more, uniform dispersion and densification of fine cells in the foam can be achieved, whereby heat insulating properties of the foam can be enhanced and the mechanical strength can be improved. The average cell diameter and the cell number density can be obtained based on an enlarged photomicrograph of a cross-section of the foam and the specific gravities of the resin before and after the foaming.

### EXAMPLES

The present invention will be described in further detail with reference to examples below, but the present invention is not limited to the examples. In the examples, apparatuses and conditions used for preparation of samples and analysis of physical properties are as follows.

(1)¹³C NMR Spectrum

Apparatus: JNM-ECA700 manufactured by JEOL Datum, Ltd.

Solvent: CDCl₃

Internal standard: CDCl₃ (77.0 ppm)

(2) Gel Permeation Chromatography (GPC)

Apparatus: HLC-8220GPC manufactured by Tosoh Corporation

Column: Shodex (registered trademark) GPC K-804L, GPC K-805L manufactured by Showa Denko K.K.

Column temperature: 40° C.

Solvent: tetrahydrofuran

Detector: RI

(3) F Quantitative Analysis (Ion Chromatography)

Apparatus: ICS-1500 manufactured by Nippon Dionex K.K.

Solvent: (2.7 mmol/L of sodium carbonate, 0.3 mmol/L of sodium bicarbonate) aqueous solution

Detector: Electric conductivity

(4) Measurement of Glass-Transition Temperature (Tg)

Apparatus: Photo-DSC 204 F1 Phoenix (registered trademark) manufactured by NETZSCH

Measurement condition: In a nitrogen atmosphere

Temperature rising rate: 5° C./min (25 to 200° C.)

(5) Measurement of 5% Weight-Loss Temperature (Td_{5%})

Apparatus: Differential heat/thermogravimetry simultaneous measuring apparatus TG-DTA2000SA manufactured by Bruker AXS K.K.

Measurement condition: In an air atmosphere

Temperature rising rate: 10° C./min (25 to 400° C.)

(6) Melting and Kneading

Apparatus: LABO PLASTOMILL 10C-100 manufactured by Toyo Seiki Seisaku-sho, Ltd.

(7) Press Molding

Apparatus: MINI TEST PRESS-10 manufactured by Toyo Seiki Seisaku-sho, Ltd.

(8) Batch-Type Foaming Apparatus (Autoclave)

Apparatus: Portable reactor TVS-N2-200 manufactured by Taiatsu Techno Corporation

(9) FE-SEM

Apparatus: JSM-7600F manufactured by JOEL Ltd.

(10) Electronic Densimeter

Apparatus; SD-120L manufactured by Alfa Mirage Co., Ltd.

The meanings of the abbreviations are as follows.

EGDMA: ethylene glycol dimethacrylate [1G manufactured by Shin Nakamura Chemical Co., Ltd.]

DVB: divinylbenzene [DVB-960 manufactured by Nippon Steel & Sumikin Chemical Co., Ltd.]

C6FA: 2-(perfluorohexyl)ethyl acrylate [CHEMINOX FAAC-6 manufactured by Unimatec Co., Ltd.]

MAIB: dimethyl 2,2′-azobisisobutyrate [MAIB manufactured by Otsuka Chemical Co., Ltd.]

AS: poly(acrylonitrile-co-styrene) [STYLAC (registered trademark) AS767 manufactured by Asahi Kasei Chemicals Corporation]

PMMA: poly(methyl methacrylate) [PARAPET (registered trademark) G manufactured by Kuraray Co., Ltd.]

PS: polystyrene [PSJ-POLYSTYRENE (registered trademark) 685 manufactured by PS Japan Corporation]

F114: perfluorobutanesulfonate [MEGAFAC (registered trademark) F-114 manufactured by DIC Corporation]

MIBK: methyl isobutyl ketone

### Synthesis Example 1

### Production of Fluorine-Containing Highly Branched Polymer (FHBP1)

32 g of toluene was put in a 200-mL reaction flask, nitrogen was fed thereinto for 5 minutes with stirring, and the flask was heated until the internal fluid was refluxed (about 110° C.).

4.0 g (20 mmol) of EGDMA as the monomer A, 4.2 g (10 mmol) of C6FA as the monomer B, 2.3 g (10 mmol) of MAIB as the initiator C, and 32 g of toluene were put in another 100-mL reaction flask, and nitrogen was fed thereinto for 5 minutes with stirring to purge the system with nitrogen.

In the toluene fluxed in the 200-mL reaction flask, the content of the 100-mL reaction flask containing EGDMA, C6FA, and MAIB was added dropwise by using a dropping pump over 30 minutes. After the completion of the dropping, the resulting solution was stirred for additional 1 hour.

Subsequently, 40 g of toluene was distilled off from this reaction solution by using a rotary evaporator, and then the residue was added to 198 g of hexane cooled in an ice bath to precipitate a polymer in the form of slurry. This slurry was filtered under reduced pressure and was vacuum dried, whereby 4.9 g of target compound (FHBP1) as white powder was obtained.

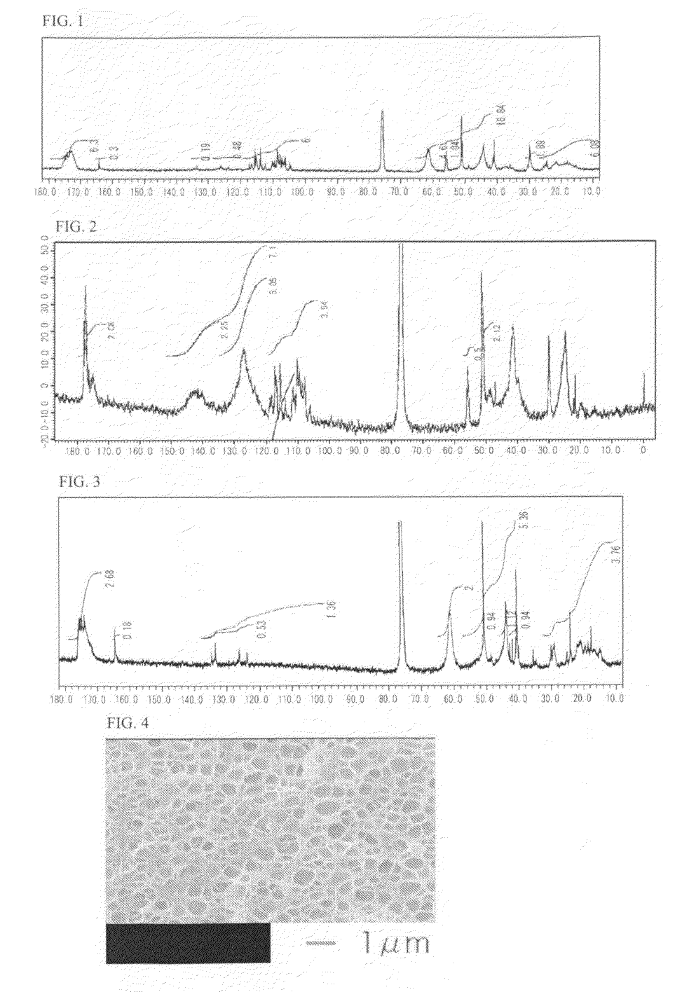

FIG. 1 illustrates a ¹³C NMR spectrum of the obtained FHBP1. The composition (molar ratio) of the unit structures of FHBP1 of the structural formulae below, which was calculated from the ¹³C NMR spectrum, was EGDMA unit [A-1]:C6FA unit [B]:MAIB unit [C]=56:22:22. The weight-average molecular weight Mw of the polymer measured by GPC in terms of polystyrene was 17,000, and the degree of distribution (Mw (weight-average molecular weight)/Mn (number-average molecular weight)) thereof was 12.

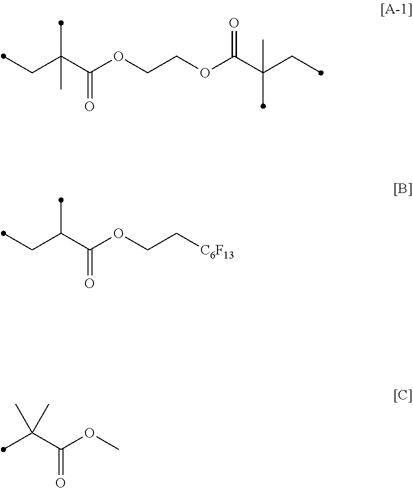

In the formulae, black dots are connection terminals.

### Synthesis Example 2

### Production of Fluorine-Containing Highly Branched Polymer (FHBP2)

521 g of MIBK was put in a 2-L reaction flask, nitrogen was fed thereinto for 5 minutes with stirring, and the flask was heated until the internal fluid was refluxed (about 116° C.).

26 g (0.2 mol) of DVB as the monomer A, 42 g (0.1 mol) of C6FA as the monomer B, 55 g (0.24 mol) of MAIB as the initiator C, and 521 g of MIBK were put in another 1-L reaction flask. Nitrogen was fed thereinto for 5 minutes with stirring to purge the system with nitrogen, and then the 1-L reaction flask was cooled to 0° C. in an ice bath.

In the MIBK fluxed in the 2-L reaction flask, the content of the 1-L reaction flask containing DVB, C6FA, and MAIB was added dropwise by using a dropping pump over 60 minutes. After the completion of the dropping, the resulting solution was stirred for additional 1 hour.

Subsequently, this reaction solution was added to 1300 g of hexane to precipitate a polymer in the form of slurry. This slurry was filtered under reduced pressure and was vacuum dried, whereby 44 g of target compound (FHBP2) as white powder was obtained.

FIG. 2 illustrates a ¹³C NMR spectrum of the obtained FHBP2. The composition (molar ratio) of the unit structures of FHBP2 of the structural formulae below, which was calculated from the ¹³C NMR spectrum, was DVB unit [A-2]:C6FA unit [B]:MAIB unit [C]=44:17:39. The weight-average molecular weight Mw of the polymer measured by GPC in terms of polystyrene was 8,800, and the degree of distribution Mw/Mn thereof was 1.5.

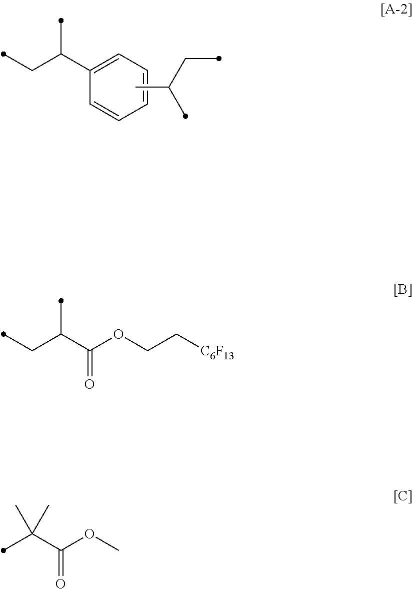

In the formulae, black dots are connection terminals.

### Synthesis Example 3

### Production of Non-Fluorine-Based Highly Branched Polymer (HBP1)

79 g of toluene was put in a 300-mL reaction flask, nitrogen was fed thereinto for 5 minutes with stirring, and the flask was heated until the internal fluid was refluxed (about 110° C.).

9.9 g (50 mmol) of EGDMA as the monomer A, 5.8 g (25 mmol) of MAIB as the initiator C, and 79 g of toluene were put in another 200-mL reaction flask, and nitrogen was fed thereinto for 5 minutes with stirring to purge the system with nitrogen.

In the toluene fluxed in the 300-mL reaction flask, the content of the 200-mL reaction flask containing EGDMA and MAIB was added dropwise by using a dropping pump over 90 minutes. After the completion of the dropping, the resulting solution was stirred for additional 1 hour.

Subsequently, this reaction solution was added to 748 g of hexane cooled in an ice bath to precipitate a polymer in the form of slurry. This slurry was filtered under reduced pressure and was vacuum dried, whereby 10.6 g of target compound (HBP1) as white powder was obtained.

FIG. 3 illustrates a ¹³C NMR spectrum of the obtained HBP1. The composition (molar ratio) of the unit structures of HBP1 of the structural formulae below, which was calculated from the ¹³C NMR spectrum, was EGDMA unit [A-1]:MAIB unit [C]=71:29. The weight-average molecular weight Mw of the polymer measured by GPC in terms of polystyrene was 17,000, and the degree of distribution Mw/Mn thereof was 4.8.

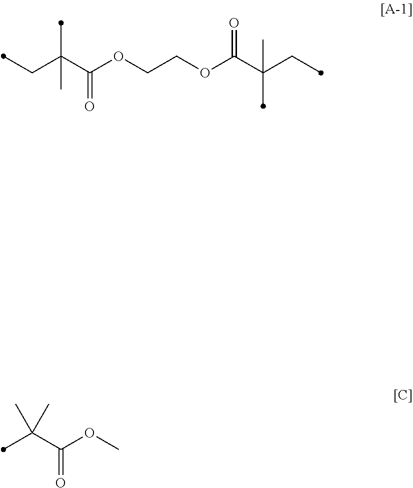

In the formulae, black dots are connection terminals.

Table 1 lists the weight-average molecular weight, the degree of distribution, the incorporated amount of the monomer B determined from the ¹³C NMR spectrum, the F atom content determined from the F quantitative analysis, the glass-transition temperature (Tg), and the 5% weight-loss temperature (Td_{5%}) of FHBP1, FHBP2, and HBP1 obtained in Synthesis Examples 1 to 3.

TABLE 1

| | | | Monomer B | | | |
|---|---|---|---|---|---|---|
| | | | introduction | F atom | | |
| | | | amount | content | Tg | Td_{5%} |
| | Mw | Mw/Mn | [mol %] | [% by mass] | [° C.] | [° C.] |
| FHBP1 | 17,000 | 2.2 | 22 | 25 | 79.6 | 272.1 |
| FHBP2 | 8,800 | 1.5 | 17 | 24 | 58.3 | 279.8 |
| HBP1 | 17,000 | 4.8 | — | — | 118.0 | 266.8 |

### Examples 1 to 6

### Production of PMMA Foam with Fluorine-Containing Highly Branched Polymer Added

[Production of PMMA Masterbatch with Fluorine-Containing Highly Branched Polymer Added]

10 g of the fluorine-containing highly branched polymers FHBP1 obtained in Synthesis Examples 1 and 10 g of the fluorine-containing highly branched polymers FHBP2 obtained in Synthesis Examples 2 were each added to 40 g of PMMA. The respective resulting mixtures were melted and kneaded using a melt kneader at a temperature of 190° C. and a screw speed of 50 rpm for 5 minutes, whereby PMMA masterbatches containing the respective fluorine-containing highly branched polymers at a concentration of 20% by mass were obtained.

[Production of PMMA Disk with Fluorine-Containing Highly Branched Polymer Added]

PMMA was further added to the masterbatches so that the concentrations of the fluorine-containing highly branched polymers became the concentrations listed in Table 2. The respective resulting mixtures were melted and kneaded at a temperature of 190° C. and a screw speed of 50 rpm for 5 minutes by a melt kneader, whereby PMMA compositions having different concentrations of the fluorine-containing highly branched polymer were obtained. The obtained compositions were put into a press-molding machine heated at 190° C., were melted over 5 minutes, and then were pressed at 1 MPa for 1 minute followed by 5 MPa for 5 minutes, whereby disk-shaped press-molded articles each having a diameter of 20 mm and a thickness of 0.5 mm were obtained.

### [Production of PMMA Foam]

The PMMA disks are put into the autoclave, the system was purged with carbon dioxide, and then the pressure was raised to 15 MPa at 50° C. for impregnation of carbon dioxide. During this process, when a reduction in pressure was observed, a valve was opened and carbon dioxide was injected to adjust the pressure, whereby the condition was maintained for 8 hours. After the 8 hours, a release valve was quickly opened for rapid decompression, and the container was opened to obtain PMMA foams.

[Evaluation of PMMA Foam with Fluorine-Containing Highly Branched Polymer Added]

The average cell diameter, the cell number density, the porosity, and the expansion ratio of each obtained PMMA foam were calculated and evaluated by the following method. The results are listed in Table 2 together. FIG. 4 illustrates a cross-sectional SEM image of a PMMA foam obtained in Example 3.

Average cell diameter: An image containing a cross-section of each foam that was observed with the FE-SEM (observation magnification of 2,000 to 40,000 times) was analyzed by an image-analysis software [Mac-View ver. 3.5 manufactured by Mountech Co., Ltd.], and the circle-equivalent diameter of a cell was calculated from the cross-sectional area thereof. The circle-equivalent diameters of 3,000 cells in total were calculated in the same manner, and the average thereof was defined as average cell diameter (D).

Cell number density: The specific gravity (ρ_{N}) of each PMMA disk before being foamed and the specific gravity (ρ_{F}) of each foam were measured with the electronic densimeter, and the cell number density (N_{f}) was calculated based on the average cell diameter (D), by the following Formula:

N_{f}=6(ρ_{N}/ρ_{F}−1)/πD³

Porosity: The porosity (V) was calculated based on the specific gravity (ρ_{N}) of each PMMA disk, the specific gravity (ρ_{F}) of each foam, by the following Formula:

V=1−ρ_{F}/ρ_{N}

Expansion ratio: The expansion ratio (E) was calculated based on the specific gravity (ρ_{N}) of each PMMA disk, the specific gravity (ρ_{F}) of each foam by the following Formula:

E=ρ_{N}/ρ_{F}

### Comparative Example 1

### Production of PMMA Foam

Operation and evaluation were performed in the same manner as in Example 1 except that the fluorine-containing highly branched polymer was not added. The results are listed in Table 2 together.

### Comparative Example 2

### Production of PMMA Foam with Non-Fluorine-Based Highly Branched Polymer Added

Operation and evaluation were performed in the same manner as in Example 4 except that the non-fluorine-based highly branched polymer HBP1 obtained in Synthesis Example 3 was used instead of the fluorine-containing highly branched polymer. The results are listed in Table 2 together.

### Comparative Example 3

### Production of PMMA Foam with Fluorine-Based Surfactant Added

Operation and evaluation were performed in the same manner as in Example 4 except that a fluorine-based surfactant F114 was used instead of the fluorine-containing highly branched polymer. The results are listed in Table 2 together.

TABLE 2

| | | Additive | Average | Cell | | |
|---|---|---|---|---|---|---|
| | | concen- | cell | number | | Expan- |
| | | tration | diam- | density | Poros- | sion |
| | Addi- | [% by | eter | [×10¹⁰ | ity | ratio |
| | tive | mass] | [μm] | cell/cm³] | [%] | [%] |
| Example 1 | FHBP1 | 0.01 | 0.47 | 463 | 0.20 | 1.25 |
| Example 2 | FHBP1 | 0.1 | 0.39 | 2,200 | 0.41 | 1.70 |
| Example 3 | FHBP1 | 0.3 | 0.34 | 3,600 | 0.39 | 1.63 |
| Example 4 | FHBP1 | 1 | 0.48 | 1,560 | 0.48 | 1.91 |
| Example 5 | FHBP1 | 3 | 0.86 | 286 | 0.49 | 1.94 |
| Example 6 | FHBP2 | 1 | 0.40 | 981 | 0.25 | 1.32 |
| Compar- | None | — | 2.16 | 3.8 | 0.17 | 1.20 |
| ative | | | | | | |
| Example 1 | | | | | | |
| Compar- | HBP1 | 1 | 4.70 | 1.0 | 0.34 | 1.53 |
| ative | | | | | | |
| Example 2 | | | | | | |
| Compar- | F114 | 1 | 2.29 | 3.6 | 0.18 | 1.22 |
| ative | | | | | | |
| Example 3 | | | | | | |

### Example 7

### Production of PS Foam with Fluorine-Containing Highly Branched Polymer Added

Operation and evaluation were performed in the same manner as in Example 4 except that PS was used instead of the PMMA and the period for impregnation of carbon dioxide was changed to 6 hours. The results are listed in Table 3.

### Comparative Example 4

### Production of PS Foam

Operation was performed in the same manner as in Example 7 except that the fluorine-containing highly branched polymer was not added. No foaming occurred, so that a PS foam was not able to be obtained.

TABLE 3

| | | Additive | Average | Cell | | |
|---|---|---|---|---|---|---|
| | | concen- | cell | number | | Expan- |
| | | tration | diam- | density | Poros- | sion |
| | Addi- | [% by | eter | [×10¹⁰ | ity | ratio |
| | tive | mass] | [μm] | cell/cm³] | [%] | [%] |
| Example 7 | FHBP1 | 1 | 0.26 | 587 | 0.05 | 1.05 |

| | | | |
|---|---|---|---|
| Compar- | None | — | No foaming |
| ative | | | |
| Example 4 | | | |

### Example 8

### Production of AS Foam with Fluorine-Containing Highly Branched Polymer Added

Operation and evaluation were performed in the same manner as in Example 4 except that AS was used instead of the PMMA and the melting and kneading temperature and the press-molding temperature were changed to 210° C., The results are listed in Table 4.

### Comparative Example 5

### Production of AS Foam

Operation and evaluation were performed in the same manner as in Example 8 except that the fluorine-containing highly branched polymer was not added. The results are listed in Table 4 together.

TABLE 4

| | | Additive | Average | Cell | | |
|---|---|---|---|---|---|---|
| | | concen- | cell | number | | Expan- |
| | | tration | diam- | density | Poros- | sion |
| | Addi- | [% by | eter | [×10¹⁰ | ity | ratio |
| | tive | mass] | [μm] | cell/cm³] | [%] | [%] |
| Example 8 | FHBP1 | 1 | 0.40 | 155 | 0.06 | 1.06 |
| Compar- | None | — | 1.66 | 1.7 | 0.04 | 1.04 |
| ative | | | | | | |
| Example 5 | | | | | | |

As listed in Table 2 to Table 4, in all of the foams of Examples 1 to 6 (PMMA), Example 7 (PS), and Example 8 (AS) using the fluorine-containing highly branched polymer (a) (FHBP1, FHBP2) of the present invention, the average cell diameters were smaller than 1 μm, and high cell number densities exceeding 150×10¹⁰ cell/cm³ were able to be achieved.

By contrast, in Comparative Example 1 (PMMA) and Comparative Example 5 (AS) not using the fluorine-containing highly branched polymer (a) (FHBP1, FHBP2) of the present invention, the average cell diameters exceed 1 μm, and the cell number densities were about 1/100 of those in Examples. In Comparative Example 3 (PS), even a foam was not able to be formed.

Furthermore, in the foams of Comparative Example 2 (PMMA) using the highly branched polymer (HBP1) containing no fluorine and Comparative Example 3 (PMMA) using the low-molecular fluorine compound (F114) instead of the fluorine-containing highly branched polymer (a), the results were obtained in which the cell diameters were large and the cell number densities were low.

As described above, it is considered that the thermoplastic resin foam of the present invention promotes impregnation of carbon dioxide because the fluorine-containing highly branched polymer has high affinity with carbon dioxide (supercritical fluid) and the fluorine-containing highly branched polymer can be highly dispersed throughout the resin. Accordingly, the thermoplastic resin foam is a foam having a high expansion ratio and containing uniform and fine cells throughout the resin.

Thus, the thermoplastic resin foam is a foam that contains fine cells in high density, and can be preferably used for, for example, automotive interior parts such as an instrument panel and a glove compartment, automotive exterior parts such as a weather strip, light-electrical parts, vibration-proof materials for electrical appliances, other industrial parts, building materials, and sporting goods.

1. A thermoplastic resin foam that is formed of a thermoplastic resin composition comprising 100 parts by mass of a thermoplastic resin (a) and 0.001 to 30 parts by mass of a fluorine-containing highly branched polymer (b), wherein
the fluorine-containing highly branched polymer (b) is a fluorine-containing highly branched polymer that is obtained by polymerizing a monomer A having in a molecule two or more radical-polymerizable double bonds with a monomer B having in a molecule a fluoroalkyl group and at least one radical-polymerizable double bond, in presence of a polymerization initiator C in an amount of 5 to 200 mol % with respect to the number of moles of the monomer A.

2. The thermoplastic resin foam according to claim 1, wherein
the monomer B is a compound that has at least either one of a vinyl group and a (meth)acrylic group.

3. The thermoplastic resin foam according to claim 2, wherein
the monomer B is a compound of Formula [1]: 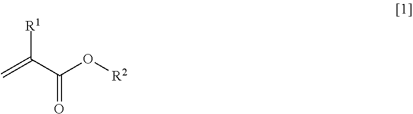
(in the formula, R¹ is a hydrogen atom or a methyl group, and R² is a C₂₋₁₂ fluoroalkyl group that is optionally substituted with a hydroxy group).

4. The thermoplastic resin foam according to claim 2, wherein
the monomer B is a compound of Formula [2]: 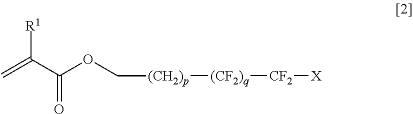
(in the formula, R¹ is a hydrogen atom or a methyl group, X is a hydrogen atom or a fluorine atom, p is an integer of 1 or 2, and q is an integer of 0 to 5).

5. The thermoplastic resin foam according to claim 1, wherein
the monomer A is a compound having either one or both of a vinyl group and a (meth)acrylic group.

6. The thermoplastic resin foam according to claim 5, wherein
the monomer A is a divinyl compound or a di(meth)acrylate compound.

7. The thermoplastic resin foam according to claim 5, wherein
the monomer A is divinylbenzene or ethylene glycol di(meth)acrylate.

8. The thermoplastic resin foam according to claim 1, wherein
the fluorine-containing highly branched polymer (b) is a fluorine-containing highly branched polymer that is obtained by polymerizing the monomer B in an amount of 5 to 300 mol % with respect to the number of moles of the monomer A.

9. The thermoplastic resin foam according to claim 1, wherein
the thermoplastic resin (a) is at least one thermoplastic resin selected from the group consisting of a poly(meth)acrylate resin and a styrene resin.

10. The thermoplastic resin foam according to claim 1, wherein
the thermoplastic resin (a) is at least one thermoplastic resin selected from the group consisting of poly(methyl methacrylate), polystyrene, and an acrylonitrile-styrene copolymer.

11. A method for producing a thermoplastic resin foam, the method comprising the steps of:
impregnating a supercritical fluid into a thermoplastic resin composition containing 100 parts by mass of a thermoplastic resin (a) and 0.001 to 30 parts by mass of a fluorine-containing highly branched polymer (b) under high pressure; and
rapidly decompressing the thermoplastic resin composition into which the supercritical fluid has been impregnated from high pressure, wherein
the fluorine-containing highly branched polymer (b) is a fluorine-containing highly branched polymer that is obtained by polymerizing a monomer A having in a molecule two or more radical-polymerizable double bonds with a monomer B having in a molecule a fluoroalkyl group and at least one radical-polymerizable double bond, in presence of a polymerization initiator C in an amount of 5 to 200 mol % with respect to the number of moles of the monomer A.

12. The production method according to claim 11, wherein
the thermoplastic resin (a) is at least one thermoplastic resin selected from the group consisting of a poly(meth)acrylate resin and a styrene resin.

13. The production method according to claim 11, wherein
the thermoplastic resin (a) is at least one thermoplastic resin selected from the group consisting of poly(methyl methacrylate), polystyrene, and an acrylonitrile-styrene copolymer.
